(19) United States
(12) Patent Application Publication
(10) Pub. No.: US 2011/0180009 A1
(43) Pub. Date: Jul. 28, 2011

(54) INCUBATOR DEVICE AND CULTIVATION PROCESS FOR FISH AND OTHER ANIMALS

(76) Inventors: Dario Francisco Giumaraes de Azevedo, Vlamao (BR); Thais Russomano, Porto Alegre (BR)

(21) Appl. No.: 13/003,061

(22) PCT Filed: Jul. 8, 2009
(86) PCT No.: PCT/BR09/00201

§ 371 Date: Apr. 12, 2011

(30) Foreign Application Priority Data
Aug. 7, 2008 (BR) P10802399.9

(51) Int. Cl. A01K 61/00

(52) U.S. Cl. 119/218

(57) ABSTRACT

The present invention discloses a device for incubating fish and other test specimens and a farming process for fish and other animals, both of which use an innovative concept for creating a microgravity environment on earth as a way to increase the efficiency of farming/development of fish and other animals in different stages of development.

### FIELD OF INVENTION

The invention herein relates to the creation of conditions that stimulate microgravity in modulation of the development of fertilized eggs of animals and of ova, alevins and/or fish and other test specimens. The following are understood as being test specimens: embryonic cells, fish larvae, alevins, animal eggs (fertilized) and foetuses. More specifically, the invention herein provides a device and process capable of inducing the effects caused by the cancellation of the gravitational acceleration vectors, thereby simulating microgravity and/or due to the minimisation of the magnetic field; the same is applied preferentially to fish ova and other test specimens during the different stages in which cell division occurs. The process used in order to simulate an environment with cancellation of the gravitational acceleration vectors and the magnetic field in fish ova and other test specimens has the following principal advantages: (1) accelerated development with regards growth; and (2) a low mortality rate, without bringing about damaging results to the species. The growth rate (volume and mass) of fish and other animals obtained by the process of the present invention is significantly greater, during the same period, when compared to the same in an environment with normal gravity.

### BACKGROUND TO INVENTION

It is know that gravity and Earth's magnetic field interfere with the development of certain organisms. The experiment which most closely resembles the concept of the present invention was performed on the 22^{nd} of January, 1992, during the STS-50 mission on board the space craft Discovery, during which chicken eggs were incubated until hatching. As part of this mission, a microgravity laboratory (IML-1), a manned pressurised Spacelab module, was taken into space in order to explore the extent of complex effects from the absence of weight on living organisms and on the processing of materials. The groups of researchers also carried out experiments as part of the study for adaptation of the human nervous system to low gravity and under the influence of microgravity, based on models in other living forms, such as lentil seeds, fly eggs and bacteria. Other experiments regarding the processing of materials in low gravity included the growing of crystals using a series of substances such as enzymes, mercury iodide and a virus. The results obtained from the studies on samples of chicken eggs demonstrated that individual eggs had a high growth rate without deformities. However, a large part of the egg samples did not even hatch. Another study, published in 2005 (Proceedings of the 2005 IEEE Engineering in Medicine and Biology 27th annual Conference, Shanghai, China: A Preliminary Biophysical Report on the Fertilized Eggs Traveled with Spaceflight), demonstrated that chicken eggs, which travelled in spacecrafts and were submitted to the condition and absence of gravity, experienced increased productivity. However, the costs and risks of sending biological matter in large quantities to space are still prohibitive, this being the reason of the search for devices which reproduce at least partially the conditions obtained in outer space.

The clinostat is a device designed to cause spatial disorientation and it was used, at the beginning of the last century, to study the reason the roots of plants grow towards the centre of the Earth. The principle of how it works is based on multiple rotations in such a way as to bring about gravitational disorientation. Normally, clinostats rotate on only one axis, known as 2D. Modern ones, however, rotate on two axes and are known as 3D clinostats. The physical reasons for the effects of clinostats have been partially known since the beginning of the 1970s. However, new developments relating to said devices—and principally regarding its new applications—arise in present times. Current scientific knowledge encompasses various publications relating to the field of microgravity. However, none of the documents found reveals or even suggest any of the objects of the present invention.

Scientific findings include studies relating to the use of devices which alter the gravitational acceleration vector in the development of fish. Studies carried out by the University of Stuttgart-Hohenheim, in Germany, demonstrate that the development of certain fish organs is influenced by hypergravity conditions and that the use of clinostats can at least in part offset the harmful effects of hypergravity. Various other studies, such as those listed below, report the use of clinostat in fish and other animals. Also listed are the evaluation of the results in passages.
Biol Sci Space. 2003 October; 17(3):165-6
The effect of clinorotation on vestibular compensation in upside-down swimming catfish.
J Gravit Physiol. 2000 July; 7(2):P97-8.
Unique postural control of upside-down swimming catfish, Synodontis nigriventris, not affected by the change of gravity.
Adv Space Res. 1999; 23(12):2045-8.
Retinal photoreceptor and related gene expression in normal and clinostat-treated fish embryos.
Adv Space Res. 2000; 25(10):1985-95.
Gravitational neurobiology of fish.
Adv Space Res. 1998; 22(2):255-64.
Neuroplastic reactivity of fish induced by altered gravity conditions: a review of recent results.
Naturwissenschaften. 1999 April; 86(4):155-67.
Effect of altered gravity on the neurobiology of fish.
Brain Res Rev. 1998 November; 28(1-2):9-18.
Neurobiology of fish under altered gravity conditions.
Adv Space Res. 1996; 17(6-7):285-8.
Influence of altered gravity on the cytochemical localization of cytochrome oxidase activity in central and peripheral gravisensory systems in developing cichlid fish.
Adv Space Res. 1996; 17(6-7):275-9.
Early development in aquatic vertebrates in near weightlessness during the D-2 Mission STATEX project.
Neurochem Int. 1995 June; 26(6):579-85.
Development and altered gravity dependent changes in glucose-6-phosphate dehydrogenase activity in the brain of the cichlid fish Oreochromis mossambicus.
Acta Astronaut. 1988 February; 17(2):257-62.
The response of structure and function of the gravireceptor in a vertebrate to near weightlessness.

However, none of the previous scientific publications or existing patents mentions the use of clinostats for the incubation of test specimens as set out in the present invention, with the goal of future industrial farming of said test specimens. Nor is there any suggestion, even indirect, regarding the various advantages of the process relating to the invention herein in the large scale farming of fish and other edible animals.

U.S. Pat. No. 3,882,634, assigned to NASA, describes a device which accelerates the growth of plants as a result of the application of rotation and translation movements on the horizontal axes, with means being provided for nutrients to be administered to said plants during the rotational movements. Horizontal planetary movement reduces the effects of gravity, thereby accelerating the growth of plants.

U.S. Pat. No. 3,911,619, assigned to Gravi-Mechanics Co., describes a device for germination of seeds, which also involves the application of rotational movements on the horizontal axes. Horizontal planetary movement reduces the effects of gravity, thereby accelerating the germination of seeds and avoiding certain problems associated with gravity.

U.S. Pat. No. 3,973,353, assigned to Gravi-Mechanics Co., describes a another device which accelerates the growth of plants by applying rotation and translation movements on the horizontal axes, with means being provided for nutrients to be administered to said plants during the rotational movements. Horizontal planetary movement reduces the effect of gravity, thereby accelerating the growth of plants.

U.S. Pat. No. 4,988,623, assigned to NASA, describes a bioreactor for cellular culture which applies rotational movements on the horizontal axes, with means being provided for nutrients to be administered to said cells during the rotational movements. Different devices for the control of nutrient flow are provided, as well as means for aerating said nutrients and temperature control mechanisms.

U.S. Pat. No. 5,155,034, assigned to NASA, describes an use of the bioreactor described in U.S. Pat. No. 4,988,623, claiming to be a method for the culture and growth of cellular tissue in mammals, under low shear conditions.

International patent application, WO 01/23595, filed by the University of Toledo (US), describes a method of genetic transformation in animal or vegetable cells, by contacting said cells with mutagenic chemical agents, or other compositions containing organisms or ingredients capable of genetic transformations, in a microgravity environment created by a clinostat. The ability of cells to undergo gene transformation by way of said agents is augmented due to the microgravity environment. Furthermore, the document reports that the production of a heterologous gene product is increased by a microgravity environment.

U.S. Pat. No. 6,726,765, assigned to Mitsubishi Heavy Industries Ltd., describes a device which crystallizes proteins in a microgavity environment. Said device applies rotational movements to the two perpendicular axes between themselves. The document reports that the crystallisation of proteins under the conditions created by the device brings about the growth of isotropic protein crystals.

U.S. Pat. No. application 2005/208650, filed by the same Japanese inventor who owns U.S. Pat. No. 6,726,765, describes the method for the culture and growth of cells or organisms in a clinostat provided with means for supplying nutrients to said cells or organisms.
The results obtained with the device and process of the present invention are surprising in light of scientific publications and known patents. The considerable advantages and beneficial outcomes of the invention provide an alternative for the production of more food products in the world. Due to the problems caused by bird flu recently, in the short term this process could be an alternative for the consumption of chicken meat.

### SUMMARY OF INVENTION

One of the objectives of the invention herein is to provide a device which simulates an environment without gravity and/or a magnetic field, for the incubation of fish and other animals.

Another objective of the invention herein is to provide a process for the large scale farming of fish and other animals. This process is comprised of at least one step involving incubation of fish and other animals in a device which simulates an environment without gravity and/or magnetic field.

Another further objective of the invention herein is to provide a process for the large scale farming of fish and other animals, which undergo accelerated growth.

Another objective of the invention herein is to provide a process for the large scale farming of fish and other animals, which experience a low mortality rate, without any harmful effects being induced.

Another objective of the invention herein is to provide a process for the large scale farming of fish and other animals, which experience a significantly higher growth rate (volume and mass), in the same time frame, when compared to others in an environment with normal gravity.

The abovementioned and other objectives of the present invention will become more apparent from the detailed description of the invention and the attached claims.

### SHORT DESCRIPTION OF THE FIGURES

FIG. 1 displays a schematic diagram of the present invention from a 3D perspective, in which: D represents a receptacle with a cylindrical shape in which the biological material is contained.

FIG. 2 displays a schematic diagram of the device in FIG. 1 from 3 technical angles, in which: A represents the base; B represents the rotating axis, C represents another rotating axis, D represents a cylindrical receptacle in which the biological material is contained.

FIG. 3 displays a schematic diagram of another version of invented device herein, from a 3D perspective, in which: D represents a spherical receptacle where the biological material is contained.

FIG. 4 displays a schematic diagram of the machine in FIG. 1 from 3 technical angles, in which: A represents the base; B represents the rotating axis, C represents another rotating axis, D represents a spherical receptacle in which the biological material is contained.

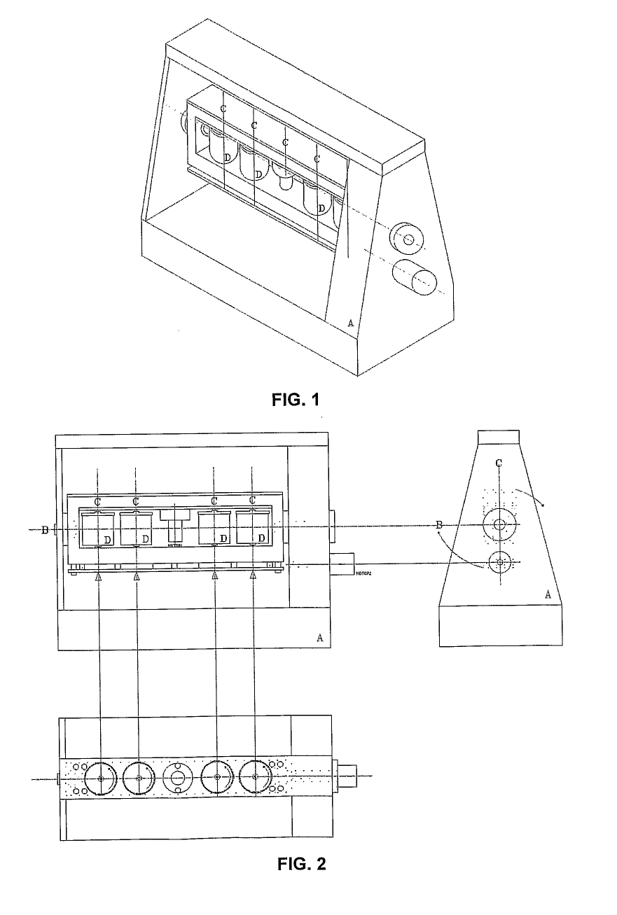

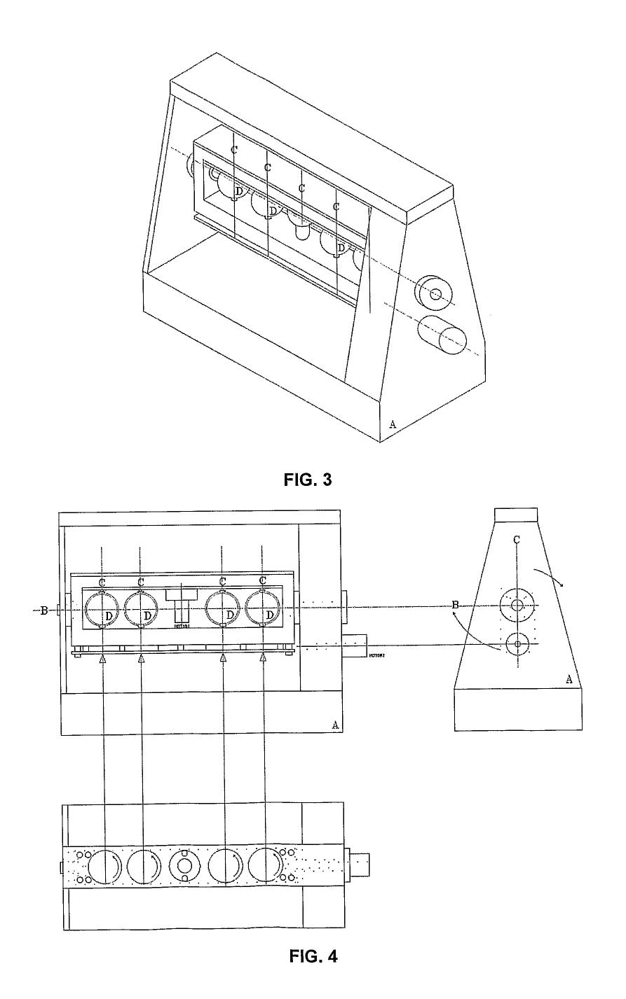

### DETAILED DESCRIPTION OF THE INVENTION

For the purposes of the invention herein, the term “fish and other animals” includes fish and other young and adult animals, as wells as their alevins, ovaries, (fertilized) eggs and other test specimens. The invention herein provides a clinostat adapted for the incubation of the fish ova, (fertilized) eggs and other test specimens and a process for the large scale farming of fish and other animals by way of the application of microgravity. Submitting fertilized fish ova, (fertilized) eggs from animals and other test specimens to a simulated environment characterised by microgravity and/or minimisation of the magnetic field is an innovative process. No other publications or reports were found on experiments related to the present invention.

The device of the present invention is capable of stimulating the development (growth/time) in fish species and other animals and it represents an enhancement and adaptation of another older device, known as the “clinostat”. In reference to the preferred version of the invented device herein, which was conceived, designed and developed by the Microgravity Centre of the Faculty of Engineering for the Catholic University of Rio Grande do Sul (PUCRS), the clinostat possesses two rotating axes (3D clinostat). Its structure was conceived as a modular piece divided in 3 principal parts: base, rotating framework and receptacles (cylinders or spheres). The base was designed in waterproof material. The structure of the rotating framework is rectangular in shape and it was designed with rigid tubes. The receptacles hold the test specimens. Each receptacle possesses quick release couplings at its ends for removal or collection of samples, even when in movement. The rotational movements of the device are obtained by way of two motors, each joined to a mechanical assembly with reduction. These two motors are responsible for rotating the vertical and horizontal axes. The device's rotating movements are controlled by way of an electronic system which feeds the motors. The rotation controller can independently adjust the rotational speed of the receptacles (containing the test specimens), on the vertical and horizontal axes.

The process of the present invention comprises at least one step of incubating fish ova and other animals in a 3D clinostat. After several periods of incubation subject to rotations that can last from a few minutes to a few days, the samples are removed from the clinostat. The incubation step has the purpose of inducing accelerated growth after the hatching and development of ova in fish and other animals.

Although the mechanisms by which increased and surprising growth occurs are unknown, it is believed that the process is a result of a reduction of the effects caused by the acceleration of gravity (that is, the simulation of microgravity) and/or by Earth's magnetic field. The device of the present invention induces these effects in fish larvae, (fertilized) animal eggs and other test specimens in a normal environment on land. In the process of the present invention, a microgravity environment is simulated by the use of a receptacle with test specimens placed under a rotating mechanism, in order to, by way of rotation of the horizontal and vertical axes, randomly accelerate the cells in such a way as to reduce the resulting gravitational vector. In a preferred embodiment, the test receptacle is comprised of four cylindrical and spherical containers. In a preferred embodiment, said containers can hold at the same time four groups of fish ova (100 thousand ova in each group) or other test specimens. In an embodiment of the process herein disclosed, fertilized fish ova species, Tilapia Nilotica, were subjected to conditions of simulated microgravity. Four sample groups were incubated in the device of the present invention for different time periods.

The device and process of the present invention advantageously provide the fertilisation and farming of fish larvae and foetuses/larvae of other animals in a normal earthly environment. The process used in order to simulate an environment with a reduction of the gravitational acceleration vector and/or the magnetic field in fish ova and other test specimens has the following main advantages: (1) accelerated development in terms of growth in the species undergoing the process; (2) a low mortality rate; (3) greater resistance in animals to aggressive external factors (diseases and climatic variations); and (4) the absence of harmful effects on the species (physiological differences were not found in the group of individuals subjected to the equipment in relation to a scientific control).

Specialists in the art of large scale farming of fish and other animals will immediately value the findings described herein and will understand the several technical, economic, environmental and sanitary advantages of the technology described herein. Small variations of the invention described herein should be understood within the spirit of the invention and the scope of the claims.

1. A device for the incubation of fish and other animals and for the simulation of the effects of microgravity, comprising:
at least one receptacle, fixed to a first rotating axis, in order to house the fish and other animals;
at least another additional rotating axis, perpendicular to the first rotating axis; and
means for providing the rotation of the said axes.

2. The device according to claim 1, further comprising two motors for rotating said axes.

3. The device according to claims 1, further comprising an electronic system for controlling the rotating movement of said axes.

4. The device according to claim 3, wherein the system for controlling the rotating movement of said axes independently adjusts the rotational speed of each of said receptacles.

5. The device according to claim 1, wherein said receptacle is cylindrical or spherical, with dimensions specific to the corresponding species of animal.

6. The device according to claim 1, wherein said receptacle comprises quick release couplings at its ends for the removal or collection of samples, even when said receptacle is in movement.

7. A process for the farming of fish and other animals comprising at least one step involving the incubation of fish and other animals in a three-dimensional clinostat.

8. The process according to claim 7, wherein said fish and other animals are at a stage in which the ova/eggs are newly fertilized.

9. The process according to claim 7, further comprising a growth step in a tank having a conventional environment.

10. The process according to claim 8, further comprising a growth step in a tank having a conventional environment.

11. The device according to claim 2, further comprising an electronic system for controlling the rotating movement of said axes.

12. The device according to claim 4 wherein said receptacle is cylindrical or spherical, with dimensions specific to the corresponding species of animal.

13. The device according to claim 4, wherein said receptacle comprises quick release couplings at its ends for the removal or collection of samples, even when said receptacle is in movement.

14. The device according to claim 5, wherein said receptacle comprises quick release couplings at its ends for the removal or collection of samples, even when said receptacle is in movement.
